(19) United States
(12) Patent Application Publication
(10) Pub. No.: US 2007/0006311 A1
(43) Pub. Date: Jan. 4, 2007

(54) System and method for managing pestware

(76) Inventors: Kevin Thomas Barton, Broomfield, CO (US); Bradley D. Stowers, Mead, CO (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/171,962

(22) Filed: Jun. 29, 2005

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

A system and method for managing pestware on protected computers are described. One embodiment is configured to generating a log file containing information indicative of pestware activity on a protected computer, send the log file to a host, and in return, receive a customized file from the host that includes customized instructions to alter consequences of the pestware activity on the protected computer. When executed at the protected computer, the customized instructions alter the consequences of the pestware on the protected computer.

### RELATED APPLICATIONS

The present application is related to commonly owned and assigned Ser. No. 10/956,578, Attorney Docket No. WEBR-002/00US, entitled System and Method for Monitoring Network Communications for Pestware, which is incorporated herein by reference.

The present application is related to commonly owned and assigned Ser. No. 10/956,573, Attorney Docket No. WEBR-003/00US, entitled System and Method For Heuristic Analysis to Identify Pestware, which is incorporated herein by reference.

The present application is related to commonly owned and assigned Ser. No. 10/956,574, Attorney Docket No. WEBR-005/00US, entitled System and Method for Pestware Detection and Removal, which is incorporated herein by reference.

The present application is related to commonly owned and assigned Ser. No. 11/086,873, Attorney Docket No. WEBR-008/00US, entitled System and Method for Removing Multiple Related Running Processes, which is incorporated herein by reference.

The present application is related to commonly owned and assigned Ser. No. 11/105,978, Attorney Docket No. WEBR-013/00US, entitled System and Method for Scanning Obfuscated Files for Pestware, which is incorporated herein by reference.

The present application is related to commonly owned and assigned Ser. No. 11/105,977, Attorney Docket No. WEBR-014/00US, entitled System and Method for Scanning Memory for Pestware Offset Signatures, which is incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization-often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to identify pestware by comparing definitions of known pestware with files and/or processes on a user's computer. Problematically, when new pestware infects a user's machine or when existing pestware is obfuscated (e.g., encrypted), the pestware does not match known pestware definitions. Although providers of pestware removal applications generate new definitions that are made available to the provider's group of subscribers on an ongoing basis, it may take weeks before a new definition is generated and dispersed to the subscriber group. Accordingly, current software is not always able to remove these types of pestware in an expedient manner and will most certainly not be satisfactory in the future.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Embodiments of the present invention include methods for managing pestware on one or more protected computers. One embodiment is configured to generate a log file containing information indicative of pestware activity on the protected computer and send the log file to a host. The log file is analyzed at the host so as to identify the information indicative of the pestware activity on the protect computer and the tailored instructions are generated to alter consequences of the pestware activity on the protected computer. The tailored instructions are sent to the protected computer and executed so as to alter the consequences of the pestware on the protected computer.

In another embodiment, the invention may be characterized as a method for managing pestware, the method including receiving a log file from each of a plurality of protected computers, analyzing each log file so as to identify the information indicative of the pestware activity on each of the plurality of protected computers, generating a plurality of customized files that are customized to alter, when instructions in each of the customized files are executed, effects of pestware activity on each of a corresponding one of the plurality of protected computers. Each of the plurality of customized files are then sent to a corresponding one of the plurality of protected computers so as to provide customized pestware management to each of the plurality of protected computers.

In yet another variation, the invention may be characterized as a method for managing pestware on a protected computer, the method including generating a log file containing information indicative of pestware activity on the protected computer and sending the log file to a host. A customized file with customized instructions to alter consequences of the pestware activity on the protected computer is then received from the host, and the customized instructions are then executed so as to alter the consequences of the pestware on the protected computer. These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a block diagram of one implementation of the present invention; and

FIG. 2 is a flowchart of one method for managing pestware on one or more protected computers in accordance with several embodiments of the present invention.

### DETAILED DESCRIPTION

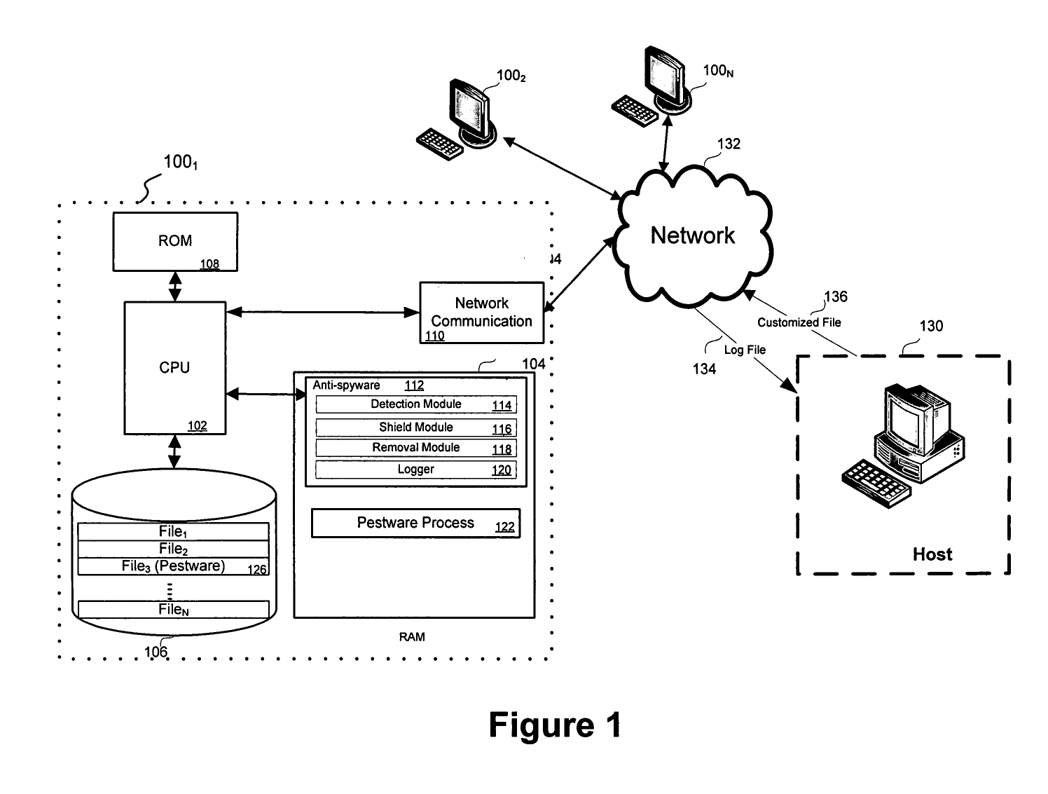

Referring now to the drawings, where like or similar elements are designated with identical reference numerals throughout the several views, and referring in particular to FIG. 1, it illustrates a block diagram of a pestware management system in accordance with one implementation of the present invention. In accordance with several embodiments, the pestware management system enables protected computers 100_{1-N} to obtain customized pestware management support from a host 130.

As shown in FIG. 1, the protected computers 100_{1-N} are in communication with the host 130 via the network 132. The term “protected computer” is used to refer to any type of computer system, including personal computers, handheld computers, servers, firewalls, etc. In the exemplary embodiment depicted in FIG. 1, one or more of the protected computers include a CPU 102 coupled to memory 104 (e.g., random access memory (RAM)), a storage device 106 (e.g., a hard drive), ROM 108 and network communication 110.

As shown, an anti-pestware application 112 includes a detection module 114, a shield module 116, a removal module 118 and an activity logger 120, which are implemented in software and are executed from the memory 104 by the CPU 102. In addition, a pestware file 126 is depicted as residing in the storage device 106 and a pestware process 122 is shown running from memory 104.

The software 112 can be configured to operate on personal computers (e.g., handheld, notebook or desktop), servers or any device capable of processing instructions embodied in executable code. Moreover, one of ordinary skill in the art will recognize that alternative embodiments, which implement one or more components (e.g., the anti-spyware 112) in hardware, are well within the scope of the present invention.

Also shown coupled to the CPU 102 is a network communication module 110, which is configured to enable communications between the protected computer 100 and the host 130 via a network 132. One of ordinary skill in the art will recognize that the network 132 and the network communication module 110 may operate in accordance with a variety of communication protocols including wireless communications protocols. Moreover, the network 132 may include one or more of a variety of network types including LANS, WANs and the Internet. In many embodiments, the host 130 and the protected computers 100_{1-N} are operated by separate entities, but this is certainly not required and in other embodiments the host 130 and protected computers 100_{1-N} are managed by the same (e.g., corporate) entity.

In the present embodiment, an operating system of the protected computer (not shown) is not limited to any particular type of operating system and may be operating systems provided by Microsoft Corp. under the trade name WINDOWS (e.g., WINDOWS 2000, WINDOWS XP, and WINDOWS NT). Additionally, the operating system may be an open source operating system such operating systems distributed under the LINUX trade name. Those of skill in the art can easily adapt these implementations for other types of operating systems or computer systems.

Referring first to the detection module 114, it is responsible for detecting pestware or pestware activity on the protected computer 100. Typically, the detection module 114 uses pestware definitions to scan the files that are stored on a computer system or that are running on a computer system. In one embodiment for example, the definition includes a representation of a pestware file (e.g., a cyclical redundancy check (CRC) of a portion of the pestware file). In such an embodiment, the protected computer then calculates a CRC for each scanned file on the protected computer and compares it to the pestware definitions to determine whether a scanned file is pestware.

The definitions can also include information about suspicious activity for which the protected computer should monitor. The detection module 114 can also check WINDOWS registry files and similar locations for suspicious entries or activities commonly associated with pestware. Further, the detection module 114 can check the hard drive for third-party cookies.

Note that the terms “registry” and “registry file” relate to any file for keeping such information as what hardware is attached, what system options have been selected, how computer memory is set up, and what application programs are to be present when the operating system is started. As used herein, these terms are not limited to WINDOWS and can be used on any operating system.

Pestware and pestware activity can also be detected by the shield module 116, which generally runs in the background on the computer system. Shields can generally be divided into two categories: those that use definitions to identify known pestware and those that look for behavior common to pestware. This combination of shield types acts to prevent known pestware and unknown pestware from running or being installed on a protected computer.

In many cases, the detection and shield modules (114 and 116) detect pestware by matching files on the protected computer with definitions of pestware, which are collected from a variety of sources. For example, host computers, protected computers and other systems can crawl the Web to actively identify pestware. These systems often download programs and search for exploits. The operation of these exploits can then be monitored and used to create pestware definitions. Various techniques for detecting pestware are disclosed in the above-identified and related application entitled: System and Method for Monitoring Network Communications for Pestware.

Notably, not all pestware is unwanted or undesirable, and automatic removal is not always an acceptable option for users of these programs. For example, popular file-sharing programs like KAZAA act as wanted spyware. Similarly, the popular GOOGLE toolbar acts as wanted spyware in certain instances. Because users typically want to retain these types of programs, embodiments of the present invention enable the user to selectively identify and retain pestware files. And in certain embodiments, the protected computer can retain a list of approved pestware so that in future sweeps, the computer does not quarantine any pestware included in the list.

Although the detection module 114 and shield module 116 are able to detect a substantial quantity of known pestware, new pestware is continually developed, and in addition, known pestware is often obfuscated or morphed utilizing various techniques. As a consequence, pestware may exist the protected computer 100 that is not readily identifiable with known definition-based approaches. According to several embodiments, the logger 120 is configured to track events on the protected computer 100 and generate a log file 134 that provides information about activities on the protected computer that may reflect pestware activities. With this log file 134, users are then able to report potential, yet not specifically identifiable, pestware activity to the host 130 by sending the log file 134 to the host 130 via the network 132.

As discussed further herein, the host 130 analyzes the log file 134, and if necessary, may request more information from the protected computer. With information from the log file 134 (e.g., information indicative of pestware activity), the administrator 130 then generates tailored instructions that are sent in a customized file 136 to the protected computer 100. In accordance with several embodiments, the instructions in the customized file 136 are tailored to the specific indications of pestware affecting the particular protected computer. In this way, the host 130 is able to generate and send customized pestware management files to each of the protected computers 100_{1-N}.

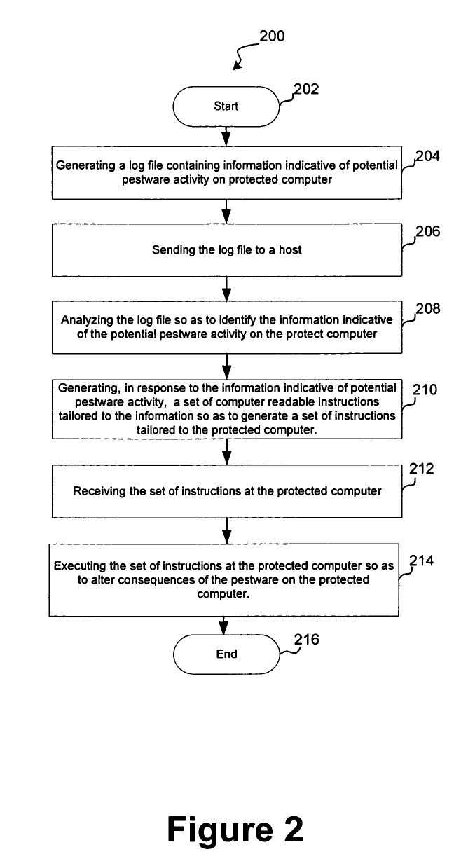

While referring to FIG. 1, simultaneous reference will be made to FIG. 2, which is a flowchart depicting steps traversed in accordance with a method to manage pestware on the protected computers 100_{1-N}. As shown in FIG. 2, a log file 134 is initially generated at the protected computer 100, which contains information indicative of pestware activity on the protected computer 100 (Blocks 202, 204). In several embodiments the log file 134 includes selected registry information from the protected computer 100. For example, the log file 134 may include a listing of running processes, loaded dynamic link libraries (DLLs), registry values (e.g., browser home page settings, run keys, services, etc.) and the contents of specified directories.

In some embodiments, a representation of running processes is included in the log file. For example, the running processes may be represented by a cyclical redundancy check (CRC) of a portion of each process or a hash function such as a message digest (e.g., MD-5).

In several embodiments, a user of the protected computer 100 initiates the generation of the log file 134 in response to suspicious activity that neither the detection module 114 nor the shield module 116 have associated with known pestware. In other embodiments, the log file 134 is generated by the logger 120 in response to the detection and/or shield modules 114, 116 identifying events on the protected computer that are consistent with events that are associated with pestware, but can not be associated, with a sufficient degree of certainty, with undesirable pestware. As discussed further herein, the generation of a log file allows the host 130 to more closely scrutinize the events on the protected computer before taking actions so as to prevent actions taken is response to false-positive identifications of undesirable pestware.

As shown if FIG. 2, after the log file 134 is generated (Block 204), it is sent to the host 130. In several embodiments the log file 134 is sent to the host 130 via email, but this is certainly not required, and one of ordinary skill in the art will recognize that various means may be used to transfer the log file from the protected computer 100 to the host 130.

Once the host 130 receives the log file 134, the host 130 analyzes the log file 134 so as to identify information within the log file 130 that is indicative of potential pestware activity (Blocks 208). In some embodiments, before an in depth analysis of the log file 134 is performed, an assessment is made as to whether the representations of the processes should have been matched at the protected computer 100 with known pestware definitions.

If the representations of the running processes do not match known definitions, then the processes are analyzed for indications of pestware. For example, pestware processes many be identified by suspicious names (e.g., names that are not expected to be found on the protected computer 100), or a pestware process that has an apparently legitimate name (e.g., because the name suggests it a legitimate system file) may be identified as potential pestware because it is in an unusual location (e.g., a location where system files are not stored).

In addition, registry information of the protected computer 100 that is captured in the log file 134 is also analyzed so as to identify parameters indicative of pestware activity. For example, settings not likely to have been chosen by a user (e.g. a page setting) may indicate pestware activity, and parameters indicating information is automatically being passed to a suspicious website (e.g., an unfamiliar website) are indicia of pestware. In some embodiments, the log file 134 is analyzed by personnel trained to recognize indications of pestware activity on the protected computer 100. One of ordinary skill in the art, however, will recognize that the log file 134 could by parsed by a computer to assist the analysis of the log file 134.

As shown in FIG. 2, in response to indications of pestware activity being identified on the protected computer 100, a set of computer readable instructions are generated and tailored to the specific indications of pestware activity on the protected computer (Block 210). These instructions are stored so as to create a customized file 136 that is tailored to address particular pestware activity on a particular protected computer. As a consequence, the exemplary pestware management system enables each of the protected computers 100_{1-N} to send a log file to the host 130, and in return, receive a customized file with instructions to alter (e.g., repair) specific consequences of pestware on each of the protected computers 100_{1-N}.

In some embodiments, the computer readable instructions are implemented as computer readable code in an executable file, which may be directly executed by the protected computer 100. In several other embodiments, the computer readable instructions are implemented as textual instructions that are readable by another file that is executed on the protected computer.

In some variations, the tailored instructions are generated, at least in part, by trained personnel. For example, in one embodiment personnel at the host site 130 may use a text editor to generate textual instructions that are tailored to the specific pestware indications of a protected computer 100. In other embodiments, the log file 134 may be read by a utility application at the host 130 that, at least partially, automates the process of generating the tailored instructions. In one embodiment, for example, a utility application may be utilized to read the log file 134 and generate a checklist style form that enables personnel at the host 130 to check certain entries (e.g., registry keys), DLLs and/or processes that should be altered (e.g., removed) at the protected computer 100. The utility application in this embodiment then converts the checklist to the tailored instructions.

After the customized file 136 is generated, it is sent to the protected computer 100 where the tailored instructions are executed so as to alter the consequences of the pestware on the protected computer (Blocks 212, 214, 216). The customized file 136 may be sent to the protected computer 100 via email or may be retrieved by the protected computer by simply downloading the file from a server at the host 130.

When the customized file 136 includes instructions in a textual form, in some embodiments, a program configured to read the instructions is sent to the protected computer 100 along with the customized file 136. When the program is installed, the customized file 136 is associated with the program so that when the customized file is selected by a user of the protected computer 100, the program that reads the customized file 136 is automatically launched.

When the tailored instructions in the customized file 136 are implemented in executable code (i.e., code that the processor 102 of the protected computer 100 is able to execute), the customized file 136 is simply executed by the protected computer 100.

Once executed, the tailored instructions direct the protected computer 100 to alter (e.g., remove and/or change) the consequences of the pestware activity on the protected computer. For example, registry keys affected by pestware may be changed, running pestware processes (e.g., the pestware process 122) may be terminated and pestware files (e.g., pestware file 126) may be removed.

In conclusion, the present invention provides, among other things, a system and method for managing pestware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing pestware on a protected computer comprising:
generating a log file containing information indicative of pestware activity on the protected computer;
sending the log file to a host;
analyzing, at the host, the log file so as to identify the information indicative of the pestware activity on the protect computer;
generating, at the host, in response to the information indicative of pestware activity, tailored instructions to alter consequences of the pestware activity on the protected computer;
sending the tailored instructions to the protected computer; and
executing the tailored instructions at the protected computer so as to alter the consequences of the pestware on the protected computer.

2. The method of claim 1, wherein the sending includes sending the log file via email to the host wherein the host is managed by a separate entity than an entity that manages the protected computer.

3. The method of claim 1, wherein the generating the log file includes generating a representation of processes running on the protected computer and including the representation of the processes in the log file, wherein the representation of the processes is selected from the group consisting of a CRC and an MD5 of the processes.

4. The method of claim 1, wherein the analyzing includes analyzing the names and locations of executable files listed in the log file.

5. The method of claim 1, wherein the analyzing includes analyzing registry information.

6. The method of claim 1, wherein the generating the tailored instructions includes parsing the log file and generating a listing of selectable information from the log file, the selectable information allowing personnel at the host to select indications of pestware to be removed from the protected computer.

7. The method of claim 1, wherein the generating the tailored instructions includes generating the tailored instructions as computer readable code, and wherein the executing includes directly executing the tailored instructions.

8. The method of claim 1, wherein the generating the tailored instructions includes generating the tailored instructions as textual instructions, wherein the executing includes converting the textual instructions into executable code.

9. A method for managing pestware comprising:
receiving a log file from each of the plurality of protected computers, wherein each log file includes information indicative of pestware activity on each of a corresponding one of the plurality of protected computers;
analyzing each log file so as to identify the information indicative of the pestware activity on each of the plurality of protected computers;
generating a plurality of customized files, wherein each of the customized files is customized to alter, when instructions in each of the customized files are executed, effects of pestware activity on each of a corresponding one of the plurality of protected computers; and
sending each of the plurality of customized files to a corresponding one of the plurality of protected computers so as to provide customized pestware management to each of the plurality of protected computers.

10. The method of claim 9, wherein the receiving includes receiving at least some of the log files via email from the plurality of protected computers.

11. The method of claim 9, wherein each of the log files includes a representation of processes running on each of the corresponding one of the plurality of protected computers, wherein the representation of the processes is selected from the group consisting of a CRC and an MD5 of the processes.

12. The method of claim 9, wherein the analyzing includes analyzing the names and locations of executable files listed in each of the plurality of log files.

13. The method of claim 9, wherein the analyzing includes analyzing registry information in each of the plurality of log files.

14. The method of claim 9, wherein the generating includes parsing each of the plurality of log files and generating, for each of the log files, a listing of selectable information from each of the log files, the selectable information allowing an administrator to select indications of pestware to be removed from each of the plurality of protected computers.

15. The method of claim 9, wherein the generating includes generating the customized files so as to include computer readable code so as to enable each of the plurality of protected computers to execute the customized files.

16. The method of claim 9, wherein the generating includes generating each of the customized files so as to include textual instructions to alter the effects of pestware activity on each of the corresponding one of the plurality of protected computers.

17. The method of claim 16, including sending, to each of the plurality of computers, an executable program, wherein the executable program is configured read and execute the textual instructions.

18. A method for managing pestware on a protected computer comprising:
generating a log file containing information indicative of pestware activity on the protected computer;
sending the log file to a host;
receiving a customized file from the host, the customized file including customized instructions, and wherein the customized instructions include instructions to alter consequences of the pestware activity on the protected computer; and
executing, utilizing the processor of the protected computer, the customized instructions so as to alter the consequences of the pestware on the protected computer.

19. The method of claim 18, wherein the sending includes sending the log file via email to the host and wherein the host is managed by a separate entity than an entity that manages the protected computer.

20. The method of claim 18, wherein the customized instructions are written in computer executable code.

21. The method of claim 18, wherein the customized instructions are written in textual form, and wherein the executing includes executing an application that converts the customized instructions in textual form to computer executable code.
